(19) United States
(12) Patent Application Publication
(10) Pub. No.: US 2020/0391429 A1
(43) Pub. Date: Dec. 17, 2020

(54) EXTRUSION PULLER CONTROL

(71) Applicant: Novatec, Inc., Baltimore, MD (US)

(72) Inventor: Robert H. BESSEMER, Allison Park, PA (US)

(73) Assignee: Novatec, Inc., Baltimore, MD (US)

(21) Appl. No.: 16/900,532

(22) Filed: Jun. 12, 2020

Related U.S. Application Data
(60) Provisional application No. 62/860,385, filed on Jun. 12, 2019.

(51) Int. Cl. B29C 48/90; B29C 48/92; B29C 48/09; B29C 48/355

(52) U.S. Cl. CPC B29C 48/903; B29C 48/92; B29C 48/09; B29C 2948/92619; B29C 2948/92114; B29C 2948/92438; B29C 2948/9258; B29C 48/355

(57) ABSTRACT

Method and apparatus for pulling polymeric material from an extrusion die as a tubular extrusion uses a pair of mutually-facing endless belts for pulling the extrusion from the extrusion die by frictional contact with the extrusion, the belts being spaced apart from one another for frictional driving passage of the tubular extrusion therebetween, spacing of the belts being continuously adjusted in response to signal from a gauge continuously measuring outer diameter of the tubular extrusion upstream of the belts.

### CROSS-REFERENCE TO RELATED APPLICATIONS

This application claims the benefit under 35 U.S.C. 119(e) of U.S. provisional application No. 62/860,385, filed Jun. 12, 2019, the contents of which are incorporated by reference herein in their entirety.

### STATEMENT REGARDING FEDERALLY SPONSORED RESEARCH OR DEVELOPMENT

Not applicable—This invention was conceived and developed entirely using private source funding; this patent application is being filed and paid for entirely by private source funding.

### BACKGROUND

Extrusion of plastic objects, including sheets of solid plastic, as thin, flexible plastic film and plastic tubes is known. Extrusion is performed by forcing plastic material, which may be in granular form as raw plastic resin or in solid or semi-solid form as pre-processed “preforms,” through an extrusion die. Most typically the plastic resin is fed to the extrusion die by a rotating plasticizing screw operating within a tubular housing. As the material is forced through the extrusion die, the internal contours and configuration of the die cause the extruded plastic material to assume the desired configuration and/or shape and/or size.

When extruding plastic into tubular form, the extruded plastic is typically pulled through and from the extrusion die. When extruding small tubes, such as those used in many medical applications, sometimes the tubular extrusion is desirably pulled through the extrusion die by a pair of parallel moving endless belts. The moving endless belts contact the tubular extrusion on opposite sides of the extrusion. The distance of the two belts from the tubular extrusion is adjustable manually and is changed before the extruding process begins, in accordance with the desired outer diameter of the tube and the particular polymer being extruded. This allows control of slippage between the tubular extrusion and the belts, as the belts pull the extrusion from the die and, typically, on through a cooling medium.

In some applications, it is desirable that the tubular extrusion be pulled from the die and through the cooling medium at a constant speed, in order to produce a tube that has constant dimensions and structural properties that do not vary along the length of the tube. If the belts are too far from the tubular extrusion, with the gap between the belts and the tubular extrusion being too large, slippage results between the tubular extrusion and the belts as the extrusion is pulled from the die, and the tubular extrusion will not be pulled at the constant speed required for production of a tube having a constant, fixed diameter that does not vary along its length.

If the gap between the belt is too small, the force exerted on tubular extrusion by the belts will be excessive and the tubular extrusion will be deformed, perhaps to the point of the tube interior being closed and the tube thus being unusable. Although the belts may be equipped with a cover formed of foam or another soft, pliable material to accommodate small variations in the diameter of the extrudate reaching the belts, this methodology cannot account for larger variations that may occur during the extruding process.

In other applications, it is desirable to purposely vary the diameter of the tube along its length to provide the tube with a particular shape, such as a catheter tube having a funnel-shaped end. In such applications, as with the manufacture of constant-diameter tubes, it is necessary to maintain an appropriate gap between the tubular extension and the belts to avoid slippage and deformation.

### SUMMARY

In one of its aspects the disclosed technology provides apparatus for pulling polymeric material from an extrusion die as a tubular extrusion where the apparatus includes a pair of mutually facing endless belts. The belts pull the tubular extrusion from the extrusion die by frictional contact with the tubular extrusion. The belts are spaced apart one from another for frictional driving passage of the tubular extrusion therebetween. In this aspect of the technology, the apparatus further includes a gauge for continuously measuring outer diameter of the tubular extrusion at a position between the die and the belts and producing an output signal indicative thereof. In this aspect of the technology, the apparatus further includes a motor for moving the belts and thereby continuously adjusting the spacing of the belts one from another in response to signal from the gauge. The gauge is preferably laser driven such that a laser beam or beams intersect the extrudate and the shadow from those beams provide data in electronic form for computation of the outer diameter of the tubular extrusion as the extrudate is pulled from the extrusion die by the puller.

In another one of its aspects, the disclosed technology provides a method for extruding a plastic tube by pulling tubular extrudate through an extrusion die with two endless belts contacting the tubular extrudate exterior on opposite sides thereof. The belts contact the tubular extrudate exterior downstream of the extrusion die. The distance between the belts is initially fixed according to a desired outer diameter of the extrudate. The method further proceeds by continuously measuring outer diameter of the tubular extrudate at a position upstream of the belts as the extrudate is pulled by frictional contact of the tubular extrudate with the moving endless belts. The method yet further proceeds by continuously adjusting distance between the belts as the tubular extrudate is pulled therebetween in a longitudinal direction by the belts. This continual distance adjustment maintains constant speed of the tube by adjustment of frictional driving contact between the belts and the tubular extrudate during passage of the extrudate between the belts, with constant speed resulting in consistent uniform diameter of the extruded tube.

In another aspect of the disclosed technology, the distance between the belts is continually adjusted to maintain a desired tube travel speed and hence a desired outer diameter of the tube that varies with the longitudinal position on the tube. The method further includes continuously measuring outer diameter of the tube preferably using a laser shadow gauge having a multiple axis coordinate system, where the method of measuring the outer diameter is performed using the laser shadow.

In yet another one of its aspects, the disclose technology provides a method for extruding a plastic tube by pulling extrudate from an extrusion die with a belt longitudinally contacting the tubular extrudate exterior downstream of the die, with distance between the belt and a spacer being fixed according to a desired outer diameter of the extrudate, where the method includes continuously measuring outer diameter of the extrudate at a position upstream of the belt as the tube is pulled by frictional contact with the moving belt, and thereafter continuously adjusting distance between the belt and the spacer as the tube is pulled therebetween by the belt to maintain desired speed of the extrudate and resultantly the desired outer diameter of the extrudate by adjustment of frictional driving contact between the belt and the extrudate during passage of the extrudate between the belt and the spacer.

The method yet further includes, in this one of its aspects, continuously adjusting distance between the belt and the spacer to maintain a desired extrudate travel speed and hence a desired outer diameter of the extrudate that varies with longitudinal position on the extrudate. In this aspect of the disclosed technology, the outer diameter of the extrudate is measured with a laser-based powered gauge having a multiple-axis coordinate system where measuring the outer diameter of the tube is desirably performed using the shadow of the laser.

In yet another one of its aspects, this disclosed technology provides apparatus for pulling polymeric material from an extrusion die to form a tubular extrusion where the apparatus includes an endless belt for pulling the tubular extrusion from the die by frictional contact with the tubular extrusion with the belt being spaced from a spacer member for frictional driving passage of the tubular extrusion therebetween by the belt as the extrusion is between the belt and the spacer member. The apparatus preferably further includes a preferably laser-based gauge for continuously measuring outer diameter of the tubular extrusion at a position between the die and the belts and producing an output signal indicative of that outer diameter. The apparatus yet further desirably includes a preferably computer-controlled motor/drive combination for moving the belt transversely to the tubular extrusion and thereby continuously adjusting spacing of the belt from the spacer member in response to signal from the gauge.

### DESCRIPTION OF THE DRAWINGS

FIG. 1 is a schematic representation of apparatus for pulling polymeric material from an extrusion die as a tubular extrusion with control being provided of the speed with which the extrudate is pulled from the die, thereby providing means for control of the outer diameter of the extrudate.

### DETAILED DESCRIPTION

The following detailed description is merely exemplary in nature and is not intended to limit the described embodiments, or uses of the described embodiments. As used herein, the words “exemplary” and “illustrative” mean “serving as an example, instance, or for illustration.” Any implementation or embodiment or abstract disclosed herein as being “exemplary” or “illustrative” is not necessarily to be construed as preferred or advantageous over other implementations, aspects, or embodiments. All of the implementations or embodiments described in the detailed description are exemplary implementations and embodiments provided to enable persons of skill in the art to make and to use the implementations and embodiments as disclosed below, to otherwise practice the technology, and are not intended to limit the scope of the invention, which is defined by the claims.

Furthermore, by this disclosure, there is no intention on the part of the Applicant to be bound by any express or implied theory presented in the preceding materials, including but not limited to the summary or the description of the prior art, or in the following detailed description. It is to be understood that the specific implementations, devices, processes, aspects, and the like illustrated in the attached drawings and described in the following portion of the application, usually referred to as the “specification,” are exemplary embodiments of the inventive concepts defined in the claims. Accordingly, specific dimensions and other physical characteristics relating to the embodiments disclosed herein are not to be considered as limiting as respecting the claims unless the claims or the specification expressly state otherwise.

The disclosed embodiments address the problem of maintaining constant speed of an extrusion as it is transported to and through a cooling medium by (i) providing a laser-based gauge continuously measuring the outer diameter of the tubular extrusion at a position between the extrusion die and the pulling belts as the tubular extrusion is pulled away from the extrusion die by the belts, (ii) continuously providing a signal from the gauge that is indicative of the instantaneously measured diameter of the tubular extrusion, and (iii) continuously adjusting the distance between the moving belts and the tubular extrusion as the belts pull the tubular extrusion away from the extrusion die to thereby maintain a constant speed of the tube as the extrudate is pulled longitudinally from the die.

A computing device desirably controls adjustment of the distance between the moving belts and the tubular extrusion. The computing device preferably can store information allowing adjustment of the distance between the moving belts and the tubular extrusion being pulled by the belts based on multiple parameters involved in the process, including but not limited to the polymer being extruded, the desired speed and speed profile of the tubular extrusion as it is pulled away from the extruder die, environmental conditions, various desired profiles/shapes of the tubular extrusion, etc.

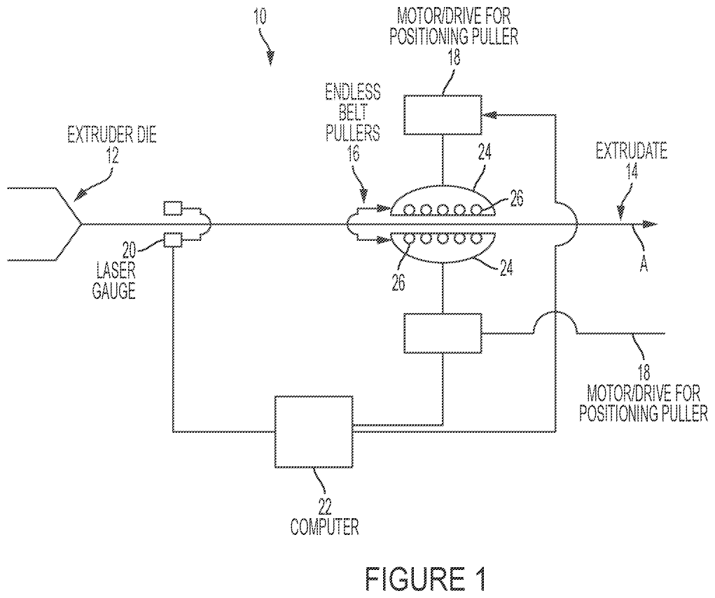

Referring to the drawing and specifically to FIG. 1, an apparatus for controlling an extruder puller and pulling extrudate from an extrusion die is illustrated generally and designated 10. The extrusion die is designated 12 and the extrudate exiting from extrusion die 12 is designated 14. The extruder puller is designated generally 16 and preferably includes two endless belts 24, which travel along pulleys or rollers 26 and are positioned for frictional, longitudinal driving contact with extrudate 14. Endless belts 24 contact the extrudate 14 and pull the extrudate in the direction indicated by arrow “A.”

A pair of motor/drive combinations 18 are provided for positioning the component parts of the extruder puller 16, specifically endless belts 24 and rollers 26, so that belts 24 contact extrudate 14 frictionally and by the motion of endless belts 24 serve to move extrudate 14 in the direction indicated by arrow “A” in FIG. 1.

A laser-based gauge designated generally 20 in FIG. 1 measures the outer diameter of extrudate 14 exiting extrusion die 12. Laser-based gauge 20 provides an output signal, indicative of the measured outer diameter of extrudate 14, to a processor such as a computer 22, as indicated in FIG. 1. Computer 22 in turn controls the motor/drive combinations 18 for positioning extruder puller 16 and specifically for positioning endless belts 24 in a desired level of frictional facing contact with extrudate 14. Computer 22 can regulate not only the position of endless belts 24 and the degree to which endless belts 24 frictionally contact extrudate 14; computer 22 can also regulate the speed of endless belts 24. Such regulation as provided by computer 22 facilitates maintenance of the desired longitudinal travel speed of extrudate 14 in the direction of arrow “A.” Maintenance of a constant speed is desirable in certain applications in order to provide a constant and unvarying outer diameter of the extrudate 14 as measured by laser-based gauge 20.

An aspect of the disclosed technology is the provision of the output signal from laser-based gauge 20 to computer 22 so that computer 22 can generate an output that, when received by the motor/drive combinations 18, causes the motor-drive combinations 18 to adjust the positions of the endless belts 24 immediately before the particular portion of extrudate 14 measured by laser-based gauge 20 reaches the endless belts 24. This sequencing of events is provided by the essentially-instantaneous transfer of the measured diameter as sensed by laser-based gauge 20 to computer 22, and the consequent adjustment of motor/drive 18, all being performed by electronic means. Thus, the signal for adjusting motor/drive combinations 18 is received by the motor/drive motor/drive combinations 18 essentially instantaneously with the generation of the diameter-measurement signal by the laser-based gauge 20. The actual time for transfer of the signals from laser-based gauge 20 to computer 22, and from computer 22 to motor/drive combinations 18 can be computed once the physical distance and length of the circuit lines, which are not numbered in FIG. 1, are known, since the speed of signal propagation through electrical lines is well known to be essentially the speed of light. Thus, the positions of the belt pullers 24 can be adjusted to an optimal spacing, or to within an optimal range of spacing, for the particular section of extrudate 14 reaching the belt pullers 24 at a given instant; and this adjustment can be conducted on a continuous, automated basis. The target spacing between the belt pullers 24 can be selected, for example, as a percentage or proportion of the desired outer diameter of the extrudate 14.

While the apparatus illustrated in FIG. 1 has been indicated to have dual endless belt pullers 24 facing one another with the extrudate passing therebetween, it is also within the scope of this disclosure to provide a single endless belt puller frictionally contacting the extrudate and having the extrudate positioned between the puller and a spacer device, which may be position adjusted by a motor/drive similar to that of motor/drive 18 indicated in FIG. 1.

It is also within the scope of this disclosure to provide a varying outer diameter of the extrudate 14 as sensed by laser-based gauge 20 by providing appropriate programming within computer 22 to adjust motor/drive 18, thereby increasing or decreasing the distance between endless belt pullers 16 as extrudate 14 passes therebetween.

Also, it is within the scope of the disclosed technology not only to adjust the outer diameter of extrudate 14 by adjusting the distance between endless belt pullers 16, but also to adjust the outer diameter of extrudate 14 by varying the speed at which endless belt pullers 16 pull extrudate 14 from extruder die 12. Of course, the faster the extrudate 14 is pulled from extruder die 12, the smaller the diameter of the resulting tube.

The laser-based gauge 20 can have a multiple-axis coordinate system included therein such that the diameter of extrudate 14 may be measured at multiple positions about the circumference of the extrudate as the extrudate passes through laser-based gauge 20.

Laser-based gauge 20 is necessarily positioned upstream of the endless belt puller 16 in order that the signal used to adjust endless belt pullers 16 is indicative of the diameter of extrudate about to reach endless belt pullers 16. Obviously, laser-based gauge 20 could not be positioned downstream of endless belt pullers 16 for the practice of the disclosed technology.

Although schematic implementations of present technology and at least some of its advantages are described in detail hereinabove, it should be understood that various changes, substitutions and alterations may be made to the apparatus and methods disclosed herein without departing from the spirit and scope of the invention as defined by the appended claims. The disclosed embodiments are therefore to be considered in all respects as being illustrative and not restrictive, with the scope of the invention being indicated by the appended claims rather than by the foregoing description. All changes which come within the meaning and range of equivalency of the claims are therefore intended to be embraced therein. Moreover, the scope of this patent application is not intended to be limited to the particular implementations of apparatus and methods described in the specification, nor to any methods that may be described or inferentially understood by those skilled in the art to be present as described in this specification.

As disclosed above and from the foregoing description of exemplary embodiments of the invention, it will be readily apparent to those skilled in the art to which the invention pertains that the principles and particularly the compositions and methods disclosed herein can be used for applications other than those specifically mentioned. Further, as one of skill in the art will readily appreciate from the disclosure of the invention as set forth hereinabove, apparatus, methods, and steps presently existing or later developed, which perform substantially the same function or achieve substantially the same result as the corresponding embodiments described and disclosed hereinabove, may be utilized according to the description of the invention and the claims appended hereto. Accordingly, the appended claims are intended to include within their scope such apparatus, methods, and processes that provide the same result or which are, as a matter of law, embraced by the doctrine of the equivalents respecting the claims of this application.

As respecting the claims appended hereto, the term “comprising” means “including but not limited to”, whereas the term “consisting of” means “having only and no more”, and the term “consisting essentially of” means “having only and no more except for minor additions which would be known to one of skill in the art as possibly needed for operation of the invention.” The scope of the invention is, therefore, indicated by the appended claims rather than by the foregoing description and all changes which come within the range of equivalency of the claims are to be considered to be embraced within the scope of the claims. Additional objects, other advantages, and further novel features of the invention will become apparent from study of the appended claims as well as from study of the foregoing detailed discussion and description of the preferred embodiments of the invention, as that study proceeds.

The following is claimed:

1. In a method for extruding a plastic tube by pulling extrudate through an extrusion die with two endless belts contacting the extrudate exterior on opposite sides thereof downstream of the die, with a distance between the belts being fixed according to a desired outer diameter of the extrudate, the improvement comprising:
a) continuously measuring an outer diameter of the extrudate at a position upstream of the belts as the extrudate is pulled by frictional contact with the two moving endless belts; and
b) continuously adjusting the distance between the belts as the extrudate is pulled longitudinally therebetween by the belts, to maintain constant speed of the extrudate by adjustment of frictional driving contact between the belts and the extrudate during passage of the extrudate between the belts.

2. The method of claim 1 wherein the improvement further comprises continuously adjusting the distance between the belts to maintain a desired extrudate travel speed and hence a desired outer diameter of the extrudate that varies with longitudinal location on the extrudate.

3. The method of claim 1 wherein the improvement further comprises continuously measuring the outer diameter of the extrudate in a laser-based gauge having a multiple axis coordinate system.

4. The method of claim 3 wherein measuring the outer diameter of the extrudate is performed using the shadow of the laser.

5. A method for extruding a plastic tube by pulling a tubular extrudate from an extrusion die with a belt continuously longitudinally contacting the tubular extrudate exterior downstream of the die, with a distance between the belt and a spacer being controlled according to a desired outer diameter of the tubular extrudate, comprising:
a) continuously measuring an outer diameter of the tubular extrudate at a position upstream of the belt as the tubular extrudate is pulled longitudinally by frictional contact with the moving belt; and
b) continuously adjusting a distance between the belt and the spacer as the tubular extrudate is pulled longitudinally therebetween by the belt, to maintain constant speed of the tubular extrudate by adjustment of frictional driving contact between the belt and the tubular extrudate during passage of the tubular extrudate between the belt and the spacer.

6. The method of claim 5 further comprising continuously adjusting a distance between the belt and the spacer to maintain a desired extrudate travel speed and hence a desired outer diameter of the tubular extrudate that varies with a longitudinal location on the tubular extrudate.

7. The method of claim 5 further comprising continuously measuring an outer diameter of the tubular extrudate with a laser-based gauge having a multiple axis coordinate system.

8. The method of claim 7 wherein measuring an outer diameter of the tubular extrudate is performed using shadow of the laser.

9. Apparatus for pulling polymeric material from an extrusion die as a tubular extrusion, comprising:
a) a pair of mutually facing endless belts for pulling the tubular extrusion from the extrusion die by frictional contact with the tubular extrusion, the belts being spaced apart from one another for frictional driving passage of the tubular extrusion therebetween;
b) a gauge for continuously measuring an outer diameter of the tubular extrusion at a position between the die and the belts and producing an output signal indicative thereof;
c) a motor for moving at least one of the belts transversely to the tubular extrusion and thereby continuously adjusting the spacing of the belts one from another in response to the output signal from the gauge.

10. Apparatus for pulling polymeric material from an extrusion die as a tubular extrusion, comprising:
a) an endless belt for pulling the tubular extrusion longitudinally from the extrusion die by frictional contact with the tubular extrusion, the belt being spaced from a spacer member for frictional driving contact of the tubular extrusion by the belt as the tubular extrusion is between the belt and the spacer member;
b) a gauge for continuously measuring an outer diameter of the tubular extrusion at a position between the die and the belt and producing an output signal indicative thereof;
c) a motor for moving the belt transversely to the tubular extrusion and thereby continuously adjusting spacing of the belt from the spacer member in response to the output signal of the gauge.
